(19) United States
(12) Patent Application Publication
(10) Pub. No.: US 2011/0155554 A1
(43) Pub. Date: Jun. 30, 2011

(54) METAL DOME PUSH BUTTON SWITCH

(75) Inventors: Yasutaka KATAOKA, Toyama (JP); Kazutomo MAESHIMA, Kanagawa (JP)

(73) Assignee: SMK CORPORATION, Tokyo (JP)

(21) Appl. No.: 12/976,936

(22) Filed: Dec. 22, 2010

(30) Foreign Application Priority Data
Dec. 25, 2009 (JP) 2009-295118

(51) Int. Cl. H01H 1/06

(52) U.S. Cl. 200/516

(57) ABSTRACT

A push button switch using a metal dome is provided that can ensure stable contact between the metal dome and fixed electrodes without using a through-hole in a PCB, can maintain the stable contact even after being operated many times, and can be obtained at low cost. The push button switch includes: a central electrode to which a circuit trace is connected without using a through-hole and with which the apex of the metal dome comes into contact when the push button switch is depressed; and an annular electrode with which the outer circumference of the metal dome is in contact. These fixed electrodes are printed with a conductive ink on the PCB, and the springy metal dome is placed over these fixed electrodes. The structure of the printed layers is identical over the entire region of the annular electrode with which region the metal dome is in contact.

### CROSS REFERENCE TO RELATED APPLICATION

The contents of the following Japanese patent application is incorporated herein by reference,
NO. 2009-295118 filed on Dec. 25, 2009.

### BACKGROUND

1. Technical Field

The present invention relates to push button switches installed in electronic and other devices and more particularly to a push button switch formed by placing a springy metal dome on a printed circuit board inside a device.

2. Description of the Related Art

One means for forming a push button switch for operating, for example, an electronic device is to use a springy metal dome. A push button switch that uses a metal dome has a better click feeling when depressed and can therefore give better operational feedback to the operator, as compared to a push button switch that uses a rubber contact, which is other typical means for forming a push button switch. Therefore, in recent years, such push button switches that use metal domes are widely used as pushbutton switches for electronic devices including mobile phones and push button switches for remote controllers for household electric appliances.

The contact section of a push button switch that uses a metal dome is formed by placing the metal dome on one of at least two fixed electrodes that are provided on a printed circuit board with a predetermined positional relationship between the electrodes. The metal dome has a function as a springy movable member and also has a function as a movable contact.

Generally, in actual products, a plurality of push button switches are formed in the following exemplary manner. A plurality of metal domes corresponding to the number of required push button switches are pasted on a base sheet cut into a predetermined shape and having an adhesive material on one side to thereby prepare the sheet with the metal domes pasted thereon in advance. The sheet with the metal domes pasted thereon is pasted on a printed circuit board such that a predetermined positional relationship is maintained. The plurality of push button switches are thereby formed only from the sheet with the metal domes pasted thereon and the printed circuit board.

Representative examples of the method of forming the fixed electrodes include a formation method including etching copper foil into a predetermined pattern and plating the surface of the etched copper foil and a formation method including printing a predetermined pattern with a conductive ink, typified by a conductive carbon ink.

The fixed electrodes of a push button switch often include: a central electrode with which the apex of a metal dome comes into contact when the push button switch is depressed; and an annular electrode with which the outer circumference of the metal dome is in contact. In the push button switch having the above configuration, the apex of the metal dome is not in contact with the central electrode when the push button switch is not depressed, and therefore the switch is electrically OFF. When the push button switch is depressed, the metal dome is distorted as the displacement of the push button in the depression direction increases. When the apex of the metal dome comes into contact with the central electrode, the fixed electrodes are electrically connected (short circuit) through the metal dome, and the push button switch is electrically ON.

A double-sided copper-clad printed circuit board having copper foil patterns on the front and rear sides and through-holes that connect the copper foil patterns on the front and rear sides is most desirable as the printed circuit board for forming push button switches using metal domes. With such a double-sided copper-clad printed circuit board, the annular electrodes can be formed into a complete doughnut shape. Through-holes are provided inside the inner circumferences of the annular electrodes, and circuit patterns on a side opposite to the side having the fixed electrodes can be connected to the central electrodes through the through holes.

In the above configuration, each metal dome is perfectly parallel to a corresponding annular electrode, and the depression load on the metal dome is equally distributed on the entire circumference of the metal dome, so that ideal mutual contact can be obtained. When a multi-layer printed circuit board is used which has a copper foil pattern on its intermediate layer in addition to copper foil patterns on the front and rear sides, a similar configuration of central electrodes and annular electrodes can be achieved using through holes.

One problem with such a double-sided copper-clad printed circuit board with through-holes that can provide ideal contact is that the circuit board is very expensive. One possible means for reducing the cost is to use a single-sided copper-clad printed circuit board having a circuit pattern only on one side and no through-holes, instead of the double-sided copper-clad printed circuit board having through-holes.

The circuit pattern on a single-sided copper-clad printed circuit board often includes conductive patterns obtained by etching copper foil and conductive patterns printed with a conductive carbon ink. In the single-sided copper-clad printed circuit board configured as above, the fixed electrodes having predetermined shapes can be easily formed by printing with the conductive carbon ink simultaneously when the conductive patterns are printed. From this point of view, this single-sided copper-clad printed circuit board is suitable for a push button switch using a metal dome.

However, since through-holes cannot be used for such a single-sided copper-clad printed circuit board, there is a difficulty in connecting circuit patterns to the central electrodes from the outside of the annular electrodes. One method to address this problem is to form each annular electrode as an arc-shaped electrode having a C-shape with a cut-out portion, and a copper foil circuit pattern is formed to extend through the cut-out portion and connected to a central electrode. One important issue in this configuration is to ensure insulation between the metal dome placed on the arc-shaped electrode and the circuit pattern extending through the cut-out portion and connected to the central electrode.

To ensure the insulation between these portions, an insulating layer is conventionally printed on the circuit pattern extending through the cut-out portion and connected to the central electrode, as shown in FIGS. 4 and 5. However, in this configuration, the printed layer structure in the arc-shaped electrode portion is different from the printed layer structure in the cut-out portion of the arc-shaped electrode, and therefore the printed film thickness in the cut-out portion of the arc-shaped electrode is greater than the printed film thickness in the arc-shaped electrode portion. This is known to result in permanent buckling inversion of the metal dome in some cases. This may also result in a contact failure between the contacts caused by shavings of the insulating layer that are scraped by the outer circumference of the metal dome when the pushbutton switch is operated (paragraphs 0006, 0007, and 0008 in Japanese Patent Application Publication No. 2002-290000). The permanent buckling inversion of the metal dome occurs when the apex of the metal dome is deformed beyond a plane defined by the outer circumference of the metal dome during depression of the metal dome.

In view of the above problem, Japanese Patent Application Publication No. 2002-290000 discloses that a first layer is formed by printing or etching and then a second layer is formed by printing or plating to form an arc-shaped portion having a two-layer structure. In this structure, the printed film thickness in the arc-shaped portion is greater than the printed film thickness in a second electrode wiring portion (paragraph 0016).

However, the thicknesses of the printed layers formed by printing can vary depending on the viscosity of the ink used for printing, the temperature and humidity of the printing environment, and other factors, and it is very difficult to control these factors to preset values or close to the preset values. Therefore, when the arc-shaped portion and an insulating coating layer on the second electrode wiring portion are formed by printing, the printed film thicknesses must be very strictly controlled to maintain a predetermined relationship between the printed heights of the printed layers, and this results in an increase in the cost of the printed circuit board.

When plating is used to increase the height of the arc-shaped electrode as disclosed in Japanese Patent Application Publication No. 2002-290000, the productivity is much lower than the productivity when printing is used, and the cost of the printed circuit board produced using plating is much higher than the cost of the printed circuit board produced without using plating. Japanese Patent Application Publication No. 2002-290000 also discloses a method in which the thickness of the second electrode wiring portion is reduced by etching or polishing (paragraph 0019). However, this method also results in an increase in the cost of the printed circuit board.

In addition, in these methods, the conventional arc-shaped fixed electrodes with cut-out portions are still used.

When a push button switch is depressed, a load in the depression direction is applied to its metal dome. Attention is now focused on the case in which the load in the depression direction from the outer circumference of the metal dome is applied to a fixed electrode on the printed circuit board, particularly to an arc-shaped portion that supports the outer circumference of the metal dome. In the arc-shaped electrode with a cut-out portion, the load is received by the arc-shaped portion. Therefore, the pressure of the load in the depression direction that is applied to a portion in contact with the outer circumference of the metal dome is larger in the arc-shaped electrode than in a complete doughnut-shaped electrode without a cut-out portion, even when the values of the depression loads on the push button switches are the same. This tendency, of course, increases as the length of the cut-out portion increases and therefore the arc length of the arc-shaped portion decreases.

When a depression load is applied to the apex of a metal dome, the diameter of its outer circumference is slightly changed as the displacement in the depression direction increases. More specifically, as the displacement of the depressed apex in the depression direction increases, the diameter of the outer circumference of the metal dome becomes slightly larger than the diameter of the outer circumference with no load applied thereto. This means that, when the push button switch is repeatedly depressed and released, sliding friction occurs between the outer circumference of the metal dome and the surface of the annular electrode or the arc-shaped electrode. It is apparent from consideration of the connection between the above fact and the pressure of the depression load described above that, since a larger pressure of the depression load is applied to the arc-shaped electrode than to the doughnut-shaped electrode, the surface of the arc-shaped electrode wears faster. This wear causes a malfunction when the push button switch is used for a long time.

As has been described above, the conventional push button switch using a metal dome includes a central electrode, a C-arc shaped electrode, a circuit pattern extending through the cut-out portion of the arc-shaped electrode and connected to the central electrode, and an insulating layer formed on the extending pattern. Such a push button switch has various fundamental problems because the metal dome is placed on a region having different printed layer structures, i.e., on the arc-shaped electrode and the insulating layer on the extending pattern.

### SUMMARY

The present invention has been made in view of the above circumstance, and it is an object of the invention to solve all the various problems in the conventional push button switch that uses an arc-shaped fixed electrode and a metal dome. More specifically, it is an object to ensure stable contact between the metal dome and the fixed electrode, to maintain the stable contact even after the pushbutton switch is operated many times, and to obtain the push button switch at low cost.

A first aspect of the present invention provides a push button switch including: fixed electrodes disposed on a printed circuit board; and a springy metal dome placed on one of the fixed electrodes, wherein the fixed electrodes include: a central electrode to which a circuit trace is connected without using a through-hole and with which an apex of the metal dome comes into contact when the push button switch is depressed; and an annular electrode which is disposed so as to surround an outer side of the central electrode and with which an outer circumference of the metal dome is in contact, and wherein the central electrode and the annular electrode are formed by printing with a conductive ink, a printed layer structure of the annular electrode being identical over an entire region with which the metal dome is in contact.

In a push button switch according to a second aspect of the present invention, a printed layer structure of at least part of the central electrode is identical to the printed layer structure of the region of the annular electrode with which the metal dome is in contact.

In a push button switch according to a third aspect of the present invention, the central electrode has a circular shape, the annular electrode has a circular doughnut shape, and the central electrode and the annular electrode are disposed concentrically. The metal dome has a circular shape and is placed concentrically on the annular electrode, and an entire outer circumference of the metal dome is in contact with the annular electrode.

In the first aspect of the present invention, the fixed electrodes disposed on the printed circuit board include: the central electrode to which a circuit trace is connected without using a through-hole; and the annular electrode disposed so as to surround the central electrode. In addition, the printed layer structure of the annular electrode is made identical over the entire region with which the metal dome is in contact. In the above configuration, the metal dome is parallel to the annular electrode, and the ideal contact that has been only achievable using a through-hole can be achieved in a printed circuit board that uses no through-holes. Therefore, all the conventional problems can be solved, such as permanent buckling inversion of the metal dome caused when the printed film thickness in the cut-out portion of the arc-shaped electrode is larger than the printed film thickness in the arc-shaped electrode and a contact failure caused by shavings of the insulating layer that are scraped by the outer circumference of the metal dome.

In addition, the printed layer structure is identical over the region of the annular electrode with which the metal dome is in contact. Therefore, even when the thicknesses of the printed layers are different from respective preset values, this difference only causes a change in the printed thickness from the base surface of the printed circuit board to the surface of the annular electrode, so that the metal dome is placed on the annular electrode with no unevenness caused by changes in the printed film thicknesses. Therefore, the present invention can be preferably applied to printed circuit boards in which the printed film thicknesses are controlled in a general manner.

In the second aspect of the present invention, the printed layer structure of at least part of the central electrode is made identical to the printed layer structure of the annular electrode, and the printed thickness of the central electrode is the same as the printed thickness of the annular electrode. This can prevent excessive displacement of the apex of the metal dome in the direction of depression, and the permanent buckling inversion of the metal dome can thereby be prevented effectively.

In the third aspect of the present invention, the entire outer circumference of the metal dome is in uniform contact with the annular electrode, and a depression load is thereby uniformly distributed on the entire outer circumference. Therefore, the pressure on the annular electrode from the outer circumference of the metal dome is lower than the pressure on a conventional arc-shaped fixed electrode, and the wear between the annular electrode and the metal dome in contact with each other is reduced. The reduction in wear of the annular electrode which has occurred in a conventional annular electrode contributes to the improvement of the operating life of the push button switch using the metal dome that is repeatedly depressed.

In addition, since a single-sided copper-clad printed circuit board with no through-holes can be used for the present invention, the pushbutton switch of the invention can be obtained at lower cost than when a conventional printed circuit board with through-holes is used. As compared to a push button switch including an arc-shaped electrode formed on a single-sided copper-clad printed circuit board, the push button switch of the invention can be obtained without an increase in cost.

### BRIEF DESCRIPTION OF THE DRAWINGS

FIG. 1 is an exploded perspective view of an embodiment of a push button switch according to the present invention that uses a metal dome.

FIG. 2 is a cross-sectional view taken along line A-A in FIG. 1 with the metal dome placed, while a base sheet is omitted.

FIG. 3a is a plan view showing the shapes of printed layers on a printed circuit board in one embodiment of the push button switch according to the present invention that uses the metal dome.

FIG. 3b is a plan view showing the shapes of printed layers on a printed circuit board in one embodiment of the push button switch according to the present invention that uses the metal dome.

FIG. 3c is a plan view showing the shapes of printed layers on a printed circuit board in one embodiment of the push button switch according to the present invention that uses the metal dome.

FIG. 3d is a plan view showing the shapes of printed layers on a printed circuit board in one embodiment of the push button switch according to the present invention that uses the metal dome.

FIG. 3e is a plan view showing the shapes of printed layers on a printed circuit board in one embodiment of the push button switch according to the present invention that uses the metal dome.

FIG. 4 is an exploded perspective view of a conventional push button switch that uses a metal dome.

FIG. 5 is a cross-sectional view taken along line B-B in FIG. 4 with the metal dome placed, while a base sheet is omitted.

### DESCRIPTION OF EXEMPLARY EMBODIMENTS

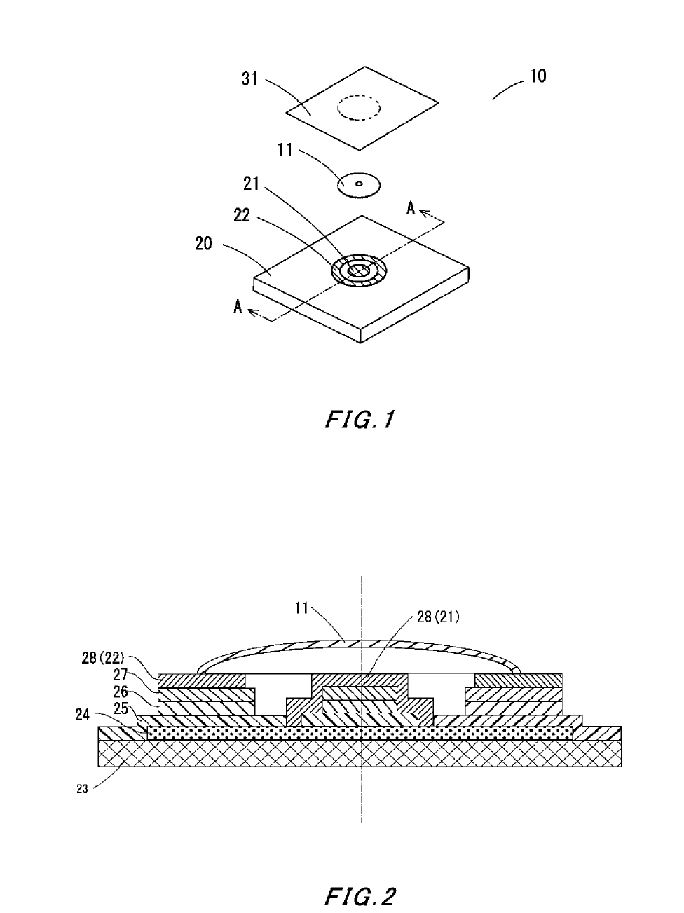

Hereinafter, a preferred embodiment of a push button switch according to the present invention that uses a perfect circular metal dome 11 having a diameter φ of 5.0 mm will be described with reference to FIGS. 1 to 3.

FIG. 1 shows the appearances of the components in the present embodiment. A circular central electrode 21 and a doughnut-shaped annular electrode 22 are disposed concentrically on a printed circuit board 20, and a perfect circular metal dome 11 is disposed concentrically over them. The metal dome 11 is pasted on a base sheet 31 in advance, and the base sheet 31 is pasted on the printed circuit board 20, so that a predetermined positional relationship with respect to the fixed electrodes is maintained. A circle indicated by a broken line in the central portion of the base sheet 31 in FIG. 1 is a portion on which the metal dome 11 is pasted.

The printed circuit board 20 used in the present embodiment is a single-sided printed circuit board having a copper foil pattern only on one side. This single-sided printed circuit board is of a simplified double-layer conductive type that uses an etched circuit pattern formed by etching the copper foil into a predetermined patterned shape and also uses a printed circuit pattern formed by printing a predetermined patterned shape with a conductive carbon ink. In the single-sided printed circuit board of the simplified double-layer conductive type, a general method to ensure insulation in a region in which an etched circuit pattern and a printed circuit pattern are stacked is to form three insulating layers, i.e., a first insulating layer 25, a second insulating layer 26, and a third insulating layer 27, in a region slightly larger than the stacked region. With this configuration, the occurrence of insulation failures when, for example, pinholes are present in the insulating layers can be significantly reduced. In the structure of the printed layers in the present embodiment, the three printed insulating layers that are required in the single-sided printed circuit board of the simplified double-layer conductive type are used, and any additional printed layer and any other layers are not required for the configuration of the present embodiment. Therefore, the production cost of the single-sided printed circuit board used in the present embodiment is the same as the production cost of the conventional single-sided printed circuit board of the simplified double-layer conductive type.

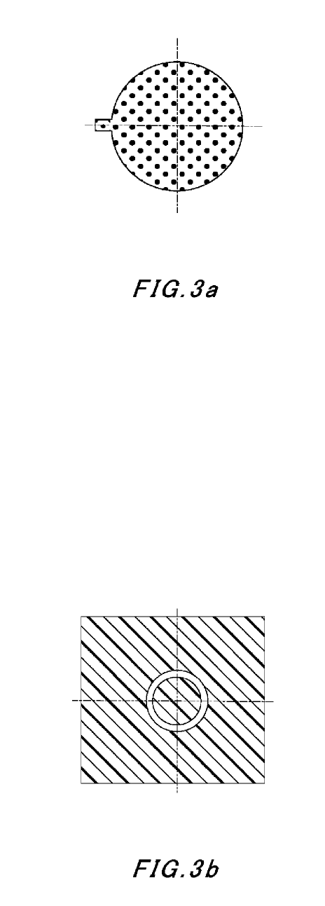

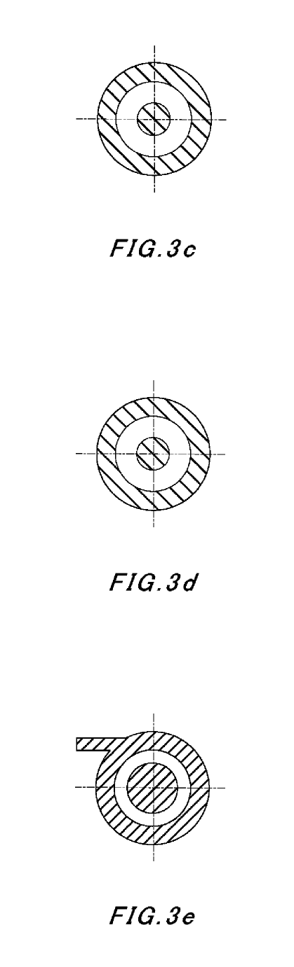

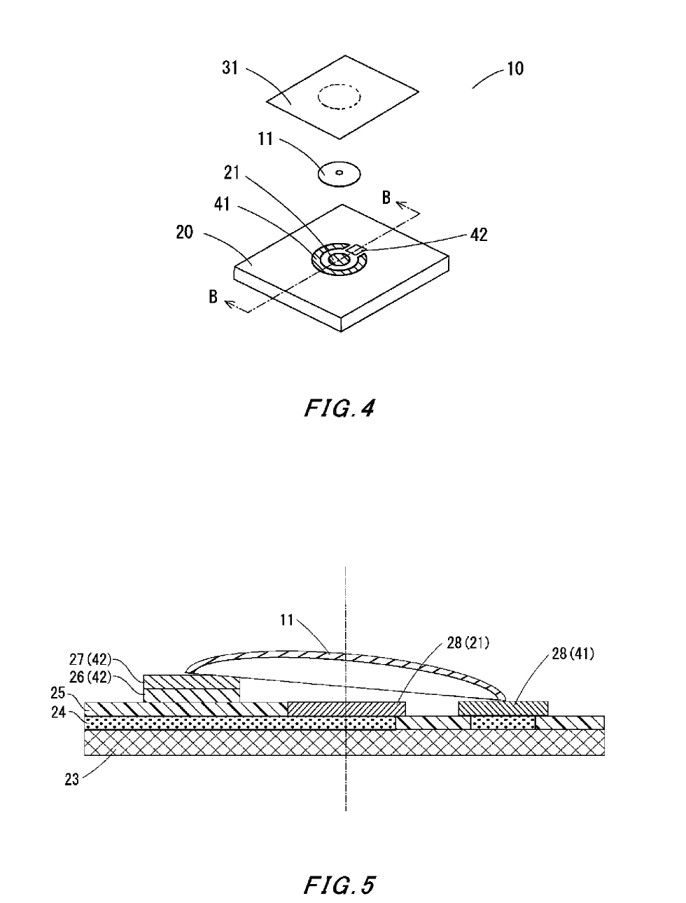

FIG. 2 is a cross-sectional view taken along line A-A in FIG. 1 and shows the details of the structures of the printed layers in the fixed electrode portions on the printed circuit board. FIGS. 3a to 3e specifically show the shapes of the printed layers used to form the central electrode 21 and the annular electrode 22 in the present embodiment. FIG. 3a shows the etched shape of the copper foil, FIG. 3b shows the printed shape of the first insulating layer 25, FIG. 3c shows the printed shape of the second insulating layer 26, FIG. 3d shows the printed shape of the third insulating layer 27, and FIG. 3e shows the printed shape of a conductive carbon layer. In FIG. 3e, a printed pattern horizontally connected to the upper left side of the annular electrode is a connection portion from an external circuit. The first insulating layer 25 may also be referred to as a “solder resist,” the second insulating layer 26 may also be referred to as a “first undercoat,” and the third insulating layer 27 may also be referred to as a “second undercoat.” Referring to FIGS. 2 and 3a to 3e, the structures and shapes of the printed layers in the present embodiment will be described in detail.

In the present embodiment, a copper foil pattern 24 is formed by etching and is slightly larger than the outer diameter of the annular electrode 22 (more specifically, φ7.0 mm).

As shown in FIG. 3a, a circuit pattern for the central electrode 21 is connected to this circular copper foil pattern from the left side in the figure (only a part of the circuit pattern is shown in the figure).

The first insulating layer 25 is printed directly on the circular copper foil pattern. The first insulating layer 25 is printed on the entire area except for a doughnut-shaped first insulating layer-unprinted region having an inner diameter of φ1.8 mm (which is smaller than the outer diameter of the central electrode 21) and an outer diameter of φ2.4 mm (which is the same as the outer diameter of the central electrode 21). The doughnut-shaped first insulating layer-unprinted region is disposed concentrically with the circular copper foil pattern 24.

The second insulating layer 26 is printed on the first insulating layer 25, and the third insulating layer 27 is printed on the second insulating layer 26. The second insulating layer 26 and the third insulating layer 27 have completely the same printed shape and are each printed in a circular region slightly smaller than the central electrode 21 and also in a doughnut-shaped region slightly larger than the annular electrode 22. The outer diameters of the second insulating layer 26 and the third insulating layer 27 printed below the central electrode 21 each are φ1.2 mm, which is smaller than the inner diameter of the first insulating layer-unprinted region. The second insulating layer 26 and the third insulating layer 27 printed below the annular electrode 22 each have an inner diameter of φ3.5 mm, which is greater than the outer diameter of the first insulating layer-unprinted region, and an outer diameter of φ6.4 mm, which is the same as the outer diameter of the annular electrode 22. Second insulating layer-printed regions and third insulating layer-printed regions below the central electrode 21 and the annular electrode 22 are disposed concentrically with the circular copper foil pattern 24.

The central electrode 21 and the annular electrode 22 are formed on the third insulating layer 27 using a conductive carbon ink. The diameter of the central electrode 21 (the size on a printing plate) is φ2.4 mm, which is slightly larger than the inner diameter of the first insulating layer-unprinted region. The inner diameter of the annular electrode 22 (the size on the printing plate) is φ4.0 mm, which is slightly larger than the outer diameter of the first insulating layer-unprinted region. The outer diameter of the annular electrode 22 (the size on the printing plate) is φ6.4 mm, which is greater than the inner diameter by 2.4 mm. The width of the annular electrode 22 is 1.2 mm. This value is determined in consideration of the tolerance of the placement position of the metal dome 11 or the tolerances of the placement positions of the printed layers on the printed circuit board 20. More specifically, the value is determined such that the metal dome 11 is disposed sufficiently within the outer diameter of the annular electrode 22 even when the maximum errors within the tolerances are accumulated.

The approximate values of the printed film thicknesses of the layers that form the fixed electrodes are as follows.

the copper foil pattern 24: 35 μm

the first insulating layer 25: 15 μm

the second insulating layer 26: 20 μm

the third insulating layer 27: 20 μm

the conductive carbon layer 28: 20 μm

A description will be given of connection of the central electrode 21 to a circuit pattern. Since the diameter of the conductive carbon layer of the central electrode 21 is greater than the diameter of the first insulating layer 25 printed in a circular shape, the conductive carbon ink used to form the central electrode 21 overflows from the circumference of the first insulating layer 25 during printing. Therefore, the conductive carbon layer that forms the central electrode 21 comes into contact with the copper foil pattern 24 exposed in the first insulating layer-unprinted region, and this mutual contact provides the connection between the central electrode 21 and the copper foil pattern 24.

As described above, in the present embodiment, the circuit pattern for the central electrode 21 is connected thereto through the copper foil pattern located below the fixed electrodes. Therefore, it is unnecessary to form a cut-out portion in the electrode in contact with the outer circumference of the metal dome to allow a copper foil circuit pattern to extend therethrough, as in the conventional arc-shaped electrode. In this manner, the annular electrode 22 can have a complete doughnut shape, and the printed layer structure on the printed circuit board can be identical over the entire region below the annular electrode 22, with the printed layer structure including five layers of the copper foil pattern 24, the first insulating layer 25, the second insulating layer 26, the third insulating layer 27, and the conductive carbon layer 28. Therefore, even when a single-sided printed circuit board is used, ideal connection between the metal dome 11 and the annular electrode 22 can be achieved as in the case in which the central electrode 21 is connected to a circuit pattern through a through-hole.

A similar printed layer structure is formed at least in a region below the central electrode 21 in which the second insulating layer 26 and the third insulating layer 27 are printed. Since this configuration can prevent excessive displacement of the apex of the metal dome 11 when the pushbutton switch 10 in the present embodiment is depressed, the permanent buckling inversion of the metal dome 11 can be effectively prevented.

A depression test with a sufficient depression load was repeated 100 thousand times on the push button switch 10 in the present embodiment. The occurrence of wear in the contact portion between the metal dome 11 and the annular electrode 22 and the occurrence of shavings were not found, so the results were very good. A depression test was performed under the same conditions on a push button switch that used a metal dome and a conventional arc-shaped electrode 41 having a cut-out portion with a large printed film thickness. The appearance after the test was observed, and flaws caused by friction with the outer circumference of the metal dome were found on the surface of an insulating layer 42 that was disposed in the cut-out portion of the arc-shaped electrode 41.

The contact resistances between the central electrode 21 and the annular electrode 22 (or the arc-shaped electrode 41) through the metal dome 11 were determined under the conditions that gave the same depression load. In the push button switch having the conventional structure, the contact resistance was in the range of 5 to 10Ω. In the present embodiment, the contact resistance was in the range of 50 to 100Ω. This is because of the following reason. In the conventional case, the contact between the copper foil pattern for the central electrode 12 and the conductive carbon ink used for printing the central electrode 12 is established over substantially the entire central electrode 21. However, in the present embodiment, the central electrode 21 is in contact with the copper foil pattern 24 only in the first insulating layer-unprinted region, as described above. Therefore, the contact area is less than that in the conventional configuration.

Generally, in an actual circuit structure for detecting the depressed state of a push button, an allowable path resistance value for correctly detecting the depressed state of the depressed pushbutton is about 10 kΩ to about 30 kΩ. The above path resistance value is the sum of the path resistance value of a circuit pattern extending from means for outputting a signal for detecting the state of the push button to one of the fixed electrodes of the push button (one of the central electrode 21 and the annular electrode 22), the contact resistance vale of the push button when it is depressed, and the path resistance value from the other fixed electrode of the push button to means to which the signal for detecting the state of the push button is inputted. In view of the above, the contact resistance in the present embodiment falls within a practical range.

The present invention can be very widely used for push down switches for electronic devices such as mobile phones and for remote controllers.

What is claimed is:

1. A push button switch, comprising:
fixed electrodes disposed on a printed circuit board; and
a springy metal dome placed on one of the fixed electrodes, wherein
the fixed electrodes comprise:
a central electrode to which a circuit trace is connected without using a through-hole and with which an apex of the metal dome comes into contact when the push button switch is depressed; and
an annular electrode which is disposed so as to surround an outer side of the central electrode and with which an outer circumference of the metal dome is in contact, and wherein
the central electrode and the annular electrode are formed by printing with a conductive ink, a printed layer structure of the annular electrode being identical over an entire region with which the metal dome is in contact.

2. The push button switch according to claim 1, wherein a printed layer structure of at least part of the central electrode is identical to the printed layer structure of the region of the annular electrode with which the metal dome is in contact.

3. The push button switch according to claim 1, wherein: the central electrode has a circular shape;
the annular electrode has a circular doughnut shape;
the central electrode and the annular electrode are disposed concentrically;
the metal dome has a circular shape and is placed concentrically on the annular electrode; and
an entire outer circumference of the metal dome is in contact with the annular electrode.
